(19) United States
(12) Patent Application Publication
(10) Pub. No.: US 2016/0173145 A1
(43) Pub. Date: Jun. 16, 2016

(54) LOW NOISE AMPLIFIER PROVIDING VARIABLE GAINS AND NOISE CANCELLATION FOR CARRIER AGGREGATION

(71) Applicant: Nvidia Corporation, Santa Clara, CA (US)

(72) Inventors: Travis Forbes, Overland Park, KS (US); Abdellatif Bellaouar, Richardson, TX (US); Sherif Abdelhalem, San Diego, CA (US); Sher Jiun Fang, Allen, TX (US); Frank Zhang, Plano, TX (US)

(21) Appl. No.: 14/838,965

(22) Filed: Aug. 28, 2015

Related U.S. Application Data
(60) Provisional application No. 62/092,679, filed on Dec. 16, 2014.

(51) Int. Cl. H04B 1/04; H04B 1/40

(52) U.S. Cl. CPC H04B 1/0475; H04B 1/40

(57) ABSTRACT

A variable-gain, low noise amplifier system includes a variable-gain, low noise amplifier, having a matching stage, coupled to an input signal with a plurality of different carrier frequencies, that provides complementary output signals containing the plurality of different carrier frequencies. The variable-gain, low noise amplifier also includes a set of carrier gain control stages, coupled to the complementary output signals, wherein each carrier gain control stage provides an independent gain for one carrier frequency of the plurality of different carrier frequencies. The variable-gain, low noise amplifier system also includes a gain controller, coupled to the variable-gain, low noise amplifier that provides gain control signals to determine the independent gain for each carrier gain control stage. A method of operating a variable-gain, low noise amplifier is also provided.

### CROSS-REFERENCE TO RELATED APPLICATION

This application claims the benefit of U.S. Provisional Application Ser. No. 62/092,679, filed by Frank Zhang, et. al, on Dec. 16, 2014, entitled “Noise-Cancelling LNA With Carrier Aggregation,” commonly assigned with this application and incorporated herein by reference.

### TECHNICAL FIELD

This application is directed, in general, to a carrier aggregation and, more specifically, to a variable-gain low noise amplifier, a method of operating a variable-gain, low noise amplifier and a variable-gain, low noise amplifier system.

### BACKGROUND

Low noise amplifiers are used in inter-carrier aggregation and intra-carrier aggregation applications where multi-frequency reception is used to increase data rates and to overcome fragmentation of assigned frequency spectrums. However, many low noise amplifier topologies suffer from degraded matching characteristics, deteriorating noise figure characteristics and reduced distortion performance when adding multiple gain paths. Additionally, they may have differing performance metrics between these multiple gain paths. What is needed in the art is an improved low noise amplifier that overcomes these problems.

### SUMMARY

Embodiments of the present disclosure provide a variable-gain low noise amplifier, a method of operating a variable-gain, low noise amplifier and a variable-gain, low noise amplifier system.

In one embodiment, the variable-gain low noise amplifier includes a matching stage coupled to an input signal having a plurality of different carrier frequencies and configured to provide complementary output signals containing the plurality of different carrier frequencies. Additionally, the variable-gain low noise amplifier also includes a set of carrier gain control stages coupled to the complementary output signals, wherein each of the set of carrier gain control stages is configured to provide an independent gain for one carrier frequency of the plurality of different carrier frequencies.

In another aspect, the method of operating a variable-gain, low noise amplifier includes receiving a plurality of different carrier frequencies, processing the plurality of different carrier frequencies into complementary signals, coupling the complementary signals to a set of independent gain control paths and providing an independent gain for one carrier frequency of the plurality of different carrier frequencies in each of the set of independent gain control paths.

In yet another aspect, the variable-gain, low noise amplifier system includes a variable-gain, low noise amplifier, having a matching stage, coupled to an input signal with a plurality of different carrier frequencies, that provides complementary output signals containing the plurality of different carrier frequencies. The variable-gain, low noise amplifier also includes a set of carrier gain control stages, coupled to the complementary output signals, wherein each carrier gain control stage provides an independent gain for one carrier frequency of the plurality of different carrier frequencies. The variable-gain, low noise amplifier system also includes a gain controller, coupled to the variable-gain, low noise amplifier that provides gain control signals to determine the independent gain for each carrier gain control stage.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

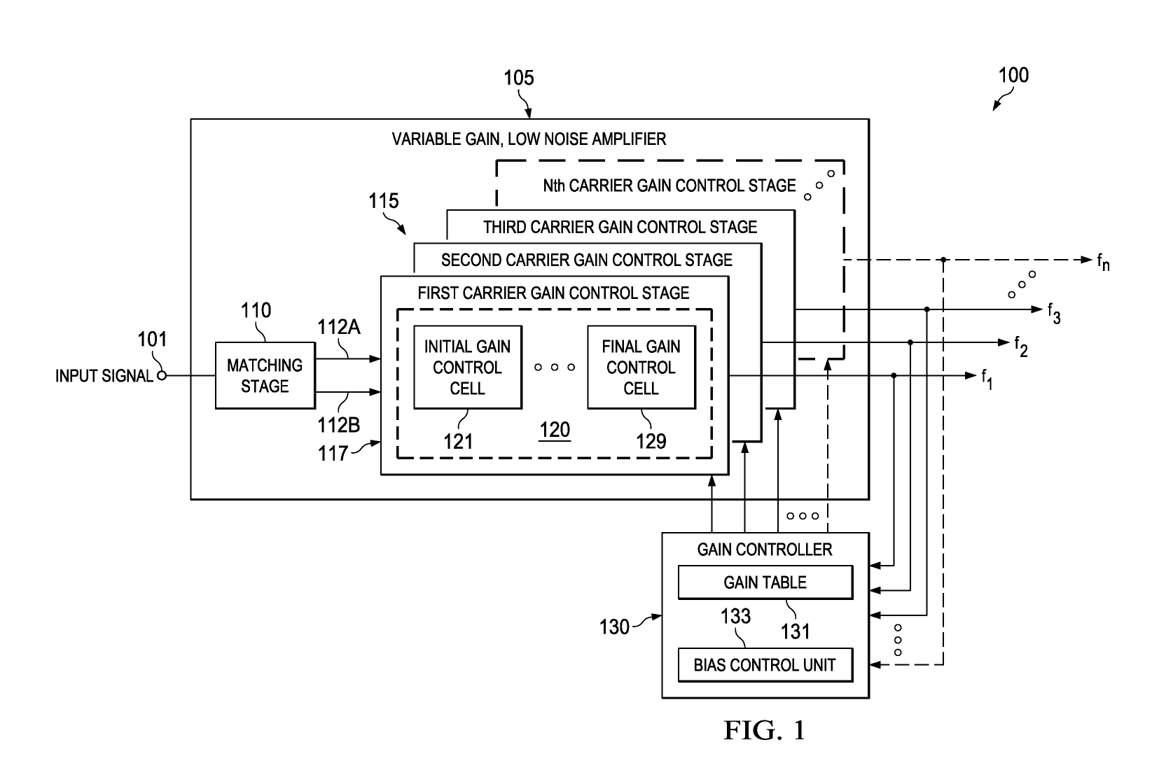

FIG. 1 illustrates an example of a variable-gain, low noise amplifier system constructed according to the principles of the present disclosure;

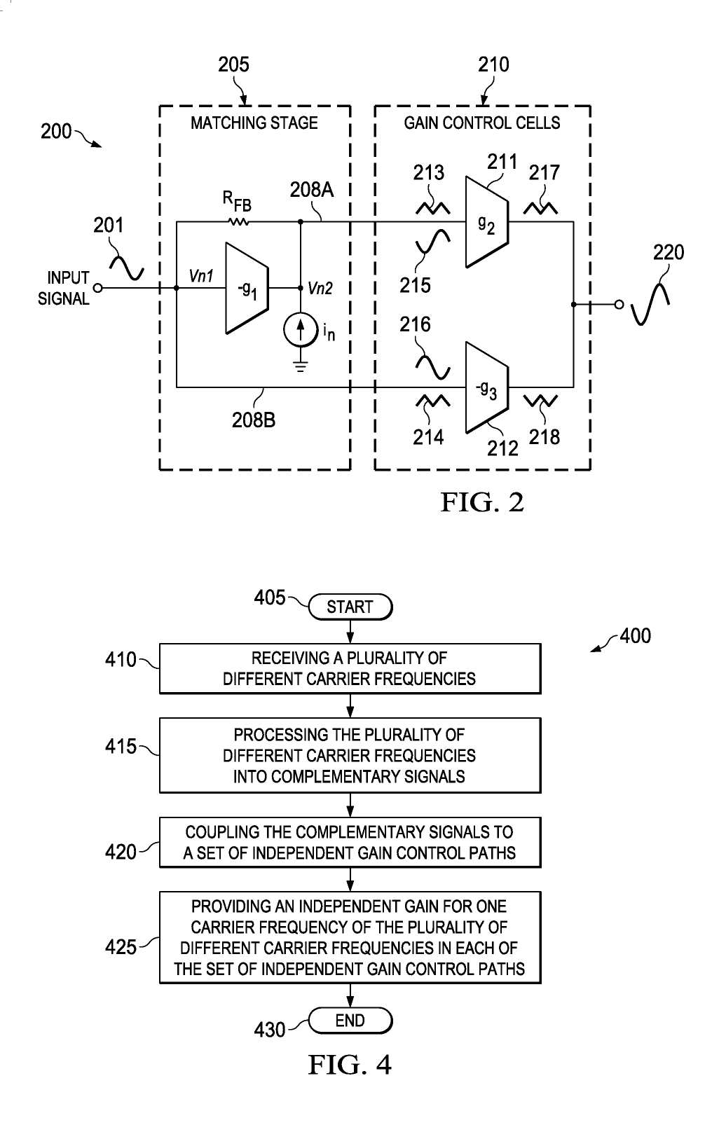

FIG. 2 illustrates an equivalent function diagram corresponding to representations of a portion of the variable gain, noise cancelling low noise amplifier of FIG. 1;

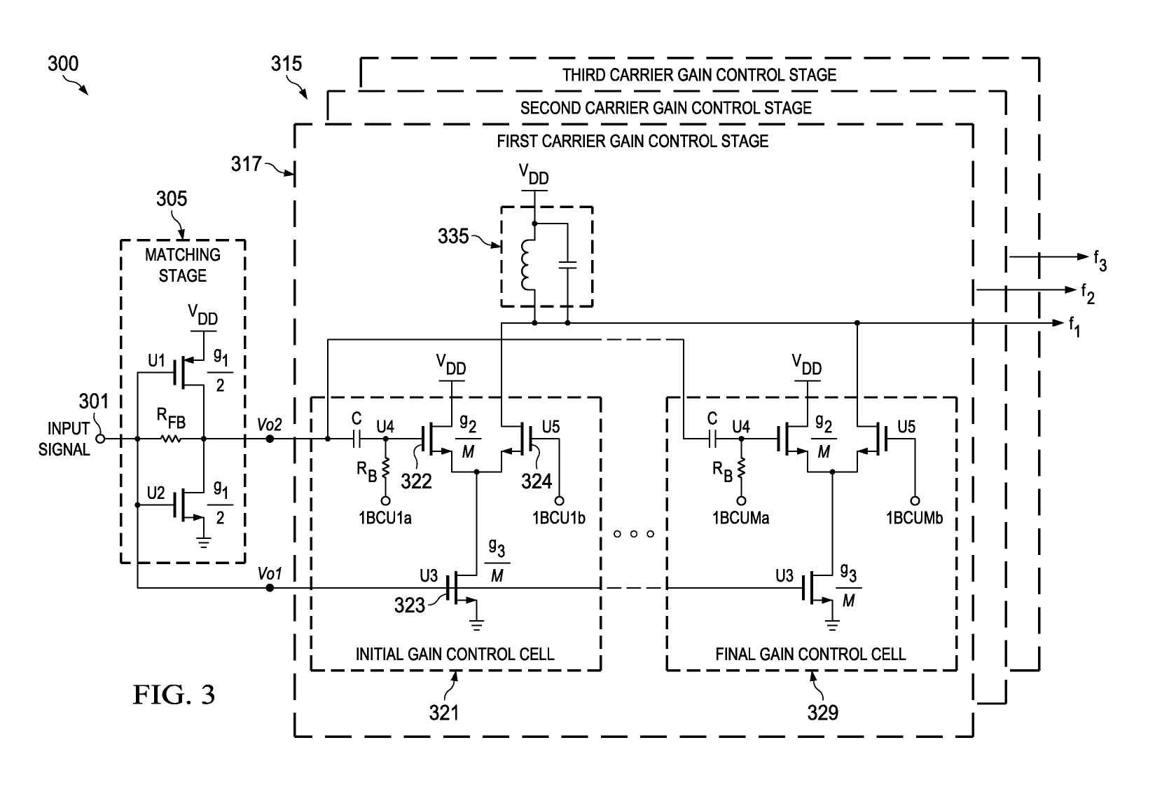

FIG. 3 illustrates an embodiment of a variable gain, noise cancelling low noise amplifier as may be employed in the low noise amplifier system of FIG. 1; and

FIG. 4 illustrates a flow diagram of an embodiment of a method of operating a variable-gain, low noise amplifier carried out according to the principles of the present disclosure.

### DETAILED DESCRIPTION

Advanced wireless standards employ carrier aggregation to increase downlink data rates by utilizing available bandwidth in multiple portions of the wireless spectrum. Separate signal channels (e.g. carriers) may be located within a single wireless band (intra-band), or may be located in multiple bands (inter-band). Within a single wireless band, the carriers may be contiguous or non-contiguous in frequency. The carriers also may arrive from a single base station (collocated), or from multiple base stations (non-collocated). In the non-collocated case, signals may arrive at a receiver having very different power levels.

In the case where two or more carriers are located within one wireless band, a single low-noise amplifier is required to provide input matching and gain for all carriers within the band. For non-contiguous carrier aggregation, the low noise amplifier is required to provide independent gain paths for each received carrier, since each carrier is down-converted to baseband by a separate mixer.

For non-contiguous, non-collocated carrier aggregation an additional requirement is placed on the low noise amplifier to receive a large carrier signal and a small carrier signal at the same time, thereby creating the requirement for independent gain control in all gain paths to prevent saturating a low noise amplifier gain stage. Maintenance of noise and distortion performance for the low noise amplifier is required for achieving carrier aggregation in all scenarios.

Embodiments of the present disclosure provide a variable gain, low noise amplifier with noise cancelling capabilities that can accommodate multiple carriers for carrier aggregation applications. Noise and distortion performance, as well as input signal matching, are maintained when achieving carrier aggregation. A noise-cancelling stage is replicated for each received carrier path by sensing noise and signal as voltages of an input matching stage. Additionally, the matching stage provides layout savings by providing DC biasing of all noise-cancelling, variable gain stages.

Each noise-cancelling gain stage is segregated into a selectable number of gain control cells allowing for carrier independent gain control as required for intra-band, non-contiguous, non-collocated carrier aggregation. Selection of only a required number of the gain control cells enables power savings for each carrier gain path. Additionally, unused carrier paths may be disabled for added power savings when receiving less than a maximum number of carriers.

FIG. 1 illustrates an example of a variable-gain, low noise amplifier system, generally designated 100, constructed according to the principles of the present disclosure. The variable-gain, low noise amplifier system 100 includes a variable gain, low noise amplifier 105 and a gain controller 130.

The variable gain, low noise amplifier 105 includes a matching stage 110 and a set of carrier gain control stages 115. Each of the set of carrier gain control stages 115 includes a plurality of gain control cells, wherein the plurality of gain control cells ranges from an initial gain control cell to a final gain control cell. The gain controller 130 includes a gain table 131 and a bias control unit 133.

The matching stage 110 is coupled to an input signal 101 having a plurality of different carrier frequencies f₁-fn and provides complementary output signals 112A, 112B containing the plurality of different carrier frequencies f₁-fn. Each of the set of carrier gain control stages 115 is coupled to the complementary output signals 112A, 112B, wherein each carrier gain control stage provides an independent gain for one carrier frequency of the plurality of different carrier frequencies f₁-fn.

Here, a first carrier gain control stage 117, corresponding to a first carrier frequency f₁, is typical of the set of carrier gain control stages 115 both in structure and operation. The first carrier gain control stage 117 includes parallel gain control cells 120 that provide the independent gain. The parallel gain control cells 120 include parallel control cells ranging from an initial control cell 121 to a final control cell 129, as shown. Outputs of the parallel gain control cells 120 are coupled to a same single carrier frequency load for the carrier frequency f₁.

Additionally, each of the complementary output signals 112A, 112B contains an interfering device noise originating from the matching stage 110. In this embodiment, the interfering device noise is an in-phase device noise that is contained in each of the complementary output signals 112A, 112B with substantially equal amplitudes. Each of these in-phase device noises may be reduced to a required level by selecting an input transconductance ratio of the parallel gain control cells 121-129 in each of the set of carrier gain control stages 115.

The gain controller 130 includes a gain table 131 and a bias control unit 133 and is coupled to the variable-gain, low noise amplifier 105 to provide gain control signals to determine the independent gain for each carrier gain control stage. The gain table 131 provides gain control information for each of the set of carrier gain control stages 115 based on its carrier frequency output amplitude, and the bias control unit 133 provides gain control for each of the set of carrier gain control stages 115 based on this gain control information.

Advantages afforded by this variable gain, low noise amplifier system 100 during reception of one or more carriers include:

1) Input matching and cancellation of the matching stage device noise is maintained;
2) Gain path performance is substantially identical when receiving any number of carrier frequencies; and
3) Each noise-cancelling stage may have separate gain programmability to support intra-band, non-contiguous, non-collocated carrier aggregation.

FIG. 2 illustrates an equivalent function diagram, generally designated 200, corresponding to representations of a portion of the variable gain, noise cancelling low noise amplifier of FIG. 1. The diagram 200 includes representations for a matching stage 205 and parallel gain control cells 210 that show noise cancelling and signal enhancing features.

The matching stage 205 is connected to an input signal 210 and is represented by a transconductance −g₁, which indicates that the matching stage 205 is signal inverting. A device noise of the matching stage 205 is represented by a noise current iₙ, which provides first and second device noise voltages vₙ₁ and vₙ₂ that are in-phase noise voltages 213, 214, as shown. However, complementary outputs 208A and 208B of the matching stage 205 provide output signal voltages 215, 216 that are complementary, as shown.

The parallel gain control cells 210 are represented by a non-inverting transconductance g₂ connected to the complementary output 208A and an inverting transconductance −g₃ connected to the complementary output 208B, as shown. The output device noises 217 and 218 are seen to be inverted and therefore subject to cancellation, while an output signal 220 is seen to be additive. The transconductance g₁ may be sized to accomplish input matching of the matching stage 205, and the transconductance ratio g₂/g₃ may be sized for noise cancellation.

FIG. 3 illustrates an embodiment of a variable gain, noise cancelling low noise amplifier, generally designated 300, as may be employed in the low noise amplifier system of FIG. 1. The variable gain, noise cancelling low noise amplifier 300 includes a matching stage 305 and a set of carrier gain control stages 315 (three carrier gain control stages accommodating three carrier frequencies f₁, f₂, f₃, in this case). Each of the set of carrier gain control stages 315 includes a set of gain control cells ranging from an initial gain control cell to a final gain control cell. Again, each of the set of carrier gain control stages 315 are structurally and operationally the same and subsequence discussions will focus on the matching stage 305 shared by all of the set of carrier gain control stages 315 and a first carrier gain control stage 317.

The matching stage 305 includes first and second transistors U1, U2 that provide equal transconductances g₁/2 and are connected in a feedback arrangement that is self-biasing employing a feedback resistor R_{FB}. The matching stage 305 is matched to an input signal 301 and provides complementary outputs Vo1, Vo2 to the set of carrier gain control stages 315. The first carrier gain control stage 317 includes multiple parallel gain control cells (M cells in this case) that range from an initial gain control cell 321 to a final gain control cell 329. The multiple parallel gain control cells share a common first carrier load 335.

Each gain control cell includes an input transistor U3 (transconductance g₃/M) directly coupled to the complementary output Vo1 and a second input transistor U4 (transconductance g₂/M) that employs a capacitor C coupled to the complementary output Vo2. The second input transistor U4 is cascode coupled to a third transistor U5, which provides gain cell output, when activated. Inputs of the first input transistors U3 of each gain control cell are coupled together, as shown. Inputs of the second input transistors U4 are also coupled together, as shown.

And, outputs of the third transistors U5 are parallel coupled to the common first carrier load 335 to provide a first carrier f₁ output. This structure employs direct biasing from the matching stage 305 and provides M stages of gain that are independently selectable. Activation and deactivation of each gain control cell is provided from voltages supplied from a gain controller through each of the biasing resistors R_{B}. As noted in FIG. 2, the transconductance ratio g₂/g₃ of the gain control cells is selected to provide noise cancellation of a device noise originating from the matching stage 305, while enhancing input signal amplitude.

FIG. 4 illustrates a flow diagram of an embodiment of a method of operating a variable-gain, low noise amplifier, generally designated 400, carried out according to the principles of the present disclosure. The method 400 starts in a step 405, and in a step 410, a plurality of different carrier frequencies are received. Then, the plurality of different carrier frequencies is processed into complementary signals, in a step 415. The complementary signals are coupled to a set of independent gain control paths, in a step 420. An independent gain for one carrier frequency of the plurality of different carrier frequencies is provided in each of the set of independent gain control paths.

In one embodiment, the independent gain is provided by a selection of parallel gain control cells in each of the set of independent gain control paths. Correspondingly, outputs of the parallel gain control cells are coupled to a same single carrier frequency load.

In another embodiment, each of the complementary output signals additionally contains an interfering device noise. In yet another embodiment, the interfering device noise is an in-phase device noise in each of the complementary signals. Correspondingly, an amplitude of the in-phase device noise is reduced to a required level by selecting an input transconductance ratio of parallel gain control in each of the set of independent gain control paths. The method ends in a step 430.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

1. A variable-gain low noise amplifier, comprising:
a matching stage coupled to an input signal having a plurality of different carrier frequencies and configured to provide complementary output signals containing the plurality of different carrier frequencies;
a set of carrier gain control stages coupled to the complementary output signals, wherein each of the set of carrier gain control stages receives each of the complementary output signals from the matching stage and each is configured to provide an independent gain for one carrier frequency of the plurality of different carrier frequencies.

2. The amplifier as recited in claim 1 wherein each of the set of carrier gain control stages includes parallel gain control cells configured to provide the independent gain.

3. The amplifier as recited in claim 2 wherein outputs of the parallel gain control cells are coupled to a same single carrier frequency load.

4. The amplifier as recited in claim 1 wherein each of the complementary output signals additionally contains an interfering device noise originating from the matching stage.

5. The amplifier as recited in claim 4 wherein the interfering device noise is an in-phase device noise in each of the complementary output signals.

6. The amplifier as recited in claim 5 wherein an amplitude of the in-phase device noise is reduced to a required level by selecting an input transconductance ratio of parallel gain control cells in each of the set of carrier gain control stages.

7. A method of operating a variable-gain, low noise amplifier, comprising:
receiving a plurality of different carrier frequencies;
processing the plurality of different carrier frequencies into complementary signals;
coupling each of the complementary signals to each of a set of independent gain control paths; and
providing an independent gain for one carrier frequency of the plurality of different carrier frequencies in each of the set of independent gain control paths.

8. The method as recited in claim 7 wherein the independent gain is provided by a selection of parallel gain control cells in each of the set of independent gain control paths.

9. The method as recited in claim 8 wherein outputs of the parallel gain control cells are coupled to a same single carrier frequency load.

10. The method as recited in claim 7 wherein each of the complementary output signals additionally contains an interfering device noise.

11. The method as recited in claim 10 wherein the interfering device noise is an in-phase device noise in each of the complementary signals.

12. The method as recited in claim 11 wherein an amplitude of the in-phase device noise is reduced to a required level by selecting an input transconductance ratio of parallel gain control in each of the set of independent gain control paths.

13. A variable-gain, low noise amplifier system, comprising:
a variable-gain, low noise amplifier, including:
a matching stage, coupled to an input signal having a plurality of different carrier frequencies, that provides complementary output signals containing the plurality of different carrier frequencies, and
a set of carrier gain control stages, each coupled to each of the complementary output signals, wherein each carrier gain control stage provides an independent gain for one carrier frequency of the plurality of different carrier frequencies; and
a gain controller, coupled to the variable-gain, low noise amplifier, that provides gain control signals to determine the independent gain for each carrier gain control stage.

14. The system as recited in claim 13 wherein each of the set of carrier gain control stages includes parallel gain control cells that provide the independent gain.

15. The system as recited in claim 14 wherein outputs of the parallel gain control cells are coupled to a same single carrier frequency load.

16. The system as recited in claim 13 wherein each of the complementary output signals additionally contains an interfering device noise originating from the matching stage.

17. The system as recited in claim 16 wherein the interfering device noise is an in-phase device noise in each of the complementary output signals.

18. The system as recited in claim 17 wherein an amplitude of the in-phase device noise is reduced to a required level by selecting an input transconductance ratio of parallel gain control cells in each of the set of carrier gain control stages.

19. The system as recited in claim 13 wherein the gain controller includes a gain table and a bias control circuit.

20. The system as recited in claim 19 wherein the gain table provides gain control information for each of the set of carrier gain control stages based on its carrier frequency output amplitude and the bias control circuit provides gain control for each of the set of carrier gain control stages based on the gain control information.
